(19) United States
(12) Patent Application Publication
(10) Pub. No.: US 2008/0008302 A1
(43) Pub. Date: Jan. 10, 2008

(54) System and method for H.323 call logging

(76) Inventor: Wai Yim, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/002,386

(22) Filed: Dec. 2, 2004

(51) Int. Cl. H04M 15/00

(52) U.S. Cl. 379/112.01

(57) ABSTRACT

A method for call-logging is provided. The method includes monitoring packet headers transmitted from and received by a port associated with a computer device. Next, the port number of the computer device is determined. Subsequently, an identification is made as to whether a communication channel for passing data has been established. If the communication channel has been established and the port number is determined to be associated with an H.323 application then the method moves on to record call start time. When the communication channel is terminated the method proceeds to record the call end time. Thereafter, the call duration is determined by subtracting the call start time from the call end time. After that, a calendar application is invoked and the call duration is logged into the calendar application.

### BACKGROUND OF THE INVENTION

1. Field of the Invention

The present invention relates generally to call-logging. More specifically, the present invention relates to a system and method for call-logging for H.323 applications.

2. Description of the Related Art

As more and more business is conducted via telecommunication networks, there is a need to maintain accurate records of the telecommunications that took place. These records not only help to keep an accurate record of the calls but also help to prevent billing errors, fraud, service discrepancies, etc. H.323 is a standard approved by the International Telecommunication Union (ITU) to promote compatibility of real-time point-to-point and multipoint audio, video, and data communication over packet based networks, such as the Internet. Many of the existing H.323 protocols or video conferencing systems include call-logging features to record users' call activities. However, many of these existing systems save the call log data in their own proprietary format. Consequently, the user will need to use a custom interface to access the data. Moreover, when the user moves from one H.323 application to another H.323 application, the user will have to learn a new user interface in order to access the call log.

Additionally, the existing technology integrates the call-logging feature into the application itself, which causes the user to access the call log through a custom interface, which in turn raises the issues described above. Accordingly, there is a need for a call-logging feature that is independent of the application and provides the user the flexibility to log the call record into an application program directly without having to use a custom interface.

### SUMMARY OF THE INVENTION

Broadly speaking, the present invention fills these needs by providing a call-logging system which functions independently of any application program and works compatibly with the existing calendar application program of a user.

The present invention provides a call-logging mechanism for standard H.323 applications without being integrated with a specific H.323 application. The present invention examines TCP/IP and/or UDP/IP packets coming in and out of a packet based system. By monitoring the TCP connection state of port 1720, this embodiment described herein can detect H.323 call connection and termination automatically. As a result, the present invention can perform H.323 call-logging without any notification from the H.323 application. Information about the call is logged directly into the existing calendar application of the user.

It should be appreciated that the present invention can be implemented in numerous ways, including as a process, an apparatus, a system, a device, or a method. Several inventive embodiments of the present invention are described below.

In one embodiment, a method for call-logging is provided. The method includes monitoring packet headers transmitted from and received by a port associated with a computer device. Then, the port number of the computer device is determined. Subsequently, an identification is made as to whether a communication channel for passing data has been established. If the communication channel has been established and the port number is determined to be associated with an H.323 application then the method moves on to record the call start time. When the communication channel is terminated, the method proceeds to record the call end time. Thereafter, the call duration is determined by subtracting the call start time from the call end time. After that, the calendar application is invoked and the call duration is logged into the calendar application.

In another embodiment, a system for call-logging is provided. The system includes a central processing unit. The system further includes a memory unit. The memory unit includes monitoring logic. The monitoring logic is configured to monitor network traffic data being received by the system. The monitoring logic detects packet types within the incoming network traffic data. The memory unit also includes logging logic. The logging logic is configured to invoke a calendar application in response to being notified by the monitoring logic that an H.323 call has ended. The logging logic logs the call duration into the calendar application.

In another embodiment, a system for call-logging is provided. The system includes a central processing unit. The system further includes a memory unit. The memory unit includes a monitoring logic. The monitoring logic is configured to monitor network traffic data being received by the system. The monitoring logic detects packet types within the incoming network traffic data. The memory unit also includes parser logic that is capable of parsing the network traffic data to extract network content data information that provides information about an incoming call. The memory unit also includes logging logic that is configured to invoke a calendar application in response to being notified by the monitoring logic that an H.323 call has ended. The logging logic logs the call duration into the calendar application program.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an exemplary packet based communication network, in accordance with an embodiment of the present invention.

FIG. 2 shows an exemplary server in accordance with an embodiment of the invention.

FIG. 3 illustrates an exemplary H.323 connection states in accordance with an embodiment of the present invention.

FIG. 4 illustrates the different network layers that are involved in managing and facilitating the call monitoring and call-logging operations in accordance with an embodiment of the present invention.

FIG. 5A shows an exemplary packet in accordance with an embodiment of the present invention.

FIG. 5B shows an exemplary TCP header in accordance with an embodiment of the present invention.

FIG. 6 illustrates network layers that are involved in managing and facilitating the call monitoring and logging operations in accordance with another embodiment of the present invention.

FIG. 7 is a flowchart providing an overview of the operations involved in automatic call-logging of H.323 calls, in accordance with an embodiment of the present invention.

### DETAILED DESCRIPTION

An invention is disclosed for call-logging for H.323 applications. In the present invention, the call logger is independent of the application programs and is adaptable to the user's existing calendar application program. The existing calendar application program is used as a database where the logger records the call duration and other information about a particular call. The invention keeps an automatic log of calls by detecting H.323 call connection and termination automatically. As a result, the invention can perform an H.323 call-logging task without any direct notification from the H.323 application.

FIG. I shows an exemplary packet based communication network, in accordance with an embodiment of the present invention. The network includes participants 120 exchanging audio, video, IP telephony, and other types of data with each other or data server 18. In such an arrangement, the data exchange can be peer-to-peer 16, client-server 114 and various combinations thereof. One skilled in the art will appreciate that in various embodiments, the communication network can be a wireless network, a wired network, or a combination thereof.

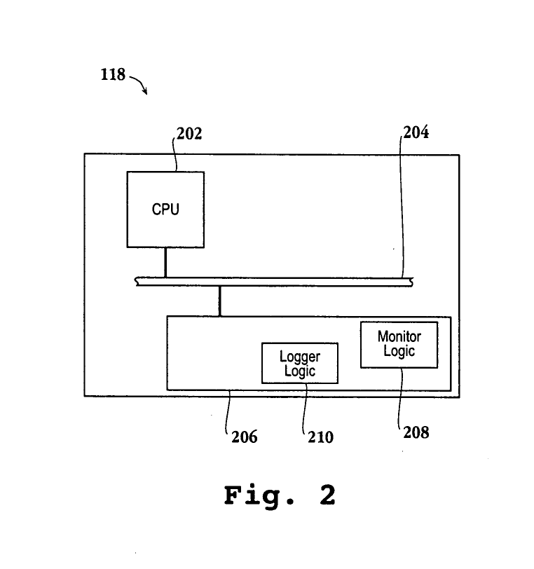

FIG. 2 shows an exemplary server 118 in accordance with an embodiment of the invention. The server 118 is shown to include a central processing unit 202 in communication with a memory unit 206 via bus 204. The memory contains monitoring logic 208 and logging logic 210. The monitoring logic 208 is configured to monitor the network traffic data that is being received by the server 118. The monitoring logic 208 watches the incoming packet headers and analyzes the headers of each packet. Further, the monitoring logic 208 also watches for the TCP connection handshake as well as for the H.323 handshake. The H.323 handshake is monitored by keeping track of the connection to port 1720, as port 1720 is the default port for the H.323 application. Once the TCP connection and H.323 handshake are complete, data is transmitted between the corresponding devices. The monitoring logic 208 keeps track of the end of the communication by monitoring the port 1720. In H.323, the initiating system of a H.323 call connection first makes a TCP connection to the server's 118 or participants' 120 TCP port 1720. When either party terminates the H.323 call, the TCP port 1720 connection is terminated. As a result, by monitoring the TCP/IP packet for port 1720, the present invention can determine when a H.323 call has been initiated and how long the call lasted. Therefore, the monitoring logic 208 can keep track of the start and end of the call by monitoring when the connection to port 1720 is established, and when the connection to port 1720 is terminated.

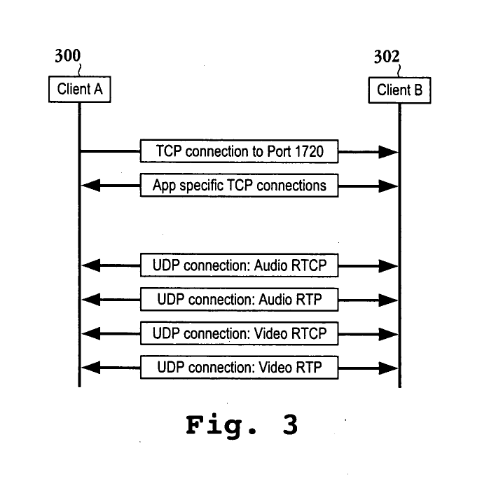

The H.323 application makes a TCP connection to another H.323 application that is listening on TCP port 1720. Then, in the subsequent data exchange, both applications open up more TCP and UDP ports for control data and media transmission. FIG. 3 illustrates the H.323 connection states. FIG. 3 includes client 300 making a connection to client 302 that is listening in on port 1720. Then, in the subsequent data exchange, both client 300 and client 302 open up more TCP and UDP connections. The connections illustrated in FIG. 3 include, application specific TCP connections, and application specific UDP connections. The application specific UDP connections include audio Real-Time Transport Control Protocol (RTCP), audio Real-Time Transport Protocol (RTP), video RTCP, video RTP. One skilled in the art will appreciate and understand that the list of TCP and UDP connections provided above is an exemplary list and is not meant to be an exhaustive list.

Whenever a new TCP connection is established, TCP packets with SYN, SYN+ACK, and ACK are exchanged between the client and the server. In order to establish a TCP connection between a client and a server, the client sends a packet with synchronize sequence numbers flag (SYN), specifying the port number of the server that the client wants to connect to, and the client's initial sequence number. The server then responds with its own packet with SYN containing the server's initial sequence number (ISN). The server also acknowledges (ACK) the client's SYN by ACKing the client's ISN plus one. The client subsequently acknowledges the SYN from the server by ACKing the server's ISN plus one. One skilled in the art will appreciate and understand that the handshake sequence described above is exemplary and that other types of handshake sequence may be used to establish a TCP connection. Whenever the connection needs to be terminated either party can send out a TCP packet with the FIN flag ON and notify the other that the TCP connection has been terminated. Accordingly, the monitoring logic 208 can determine the initiation and termination of H.323 calls by monitoring the TCP/IP packet for port 1720 with TCP flag SYN or FIN.

Referring back to FIG. 2, the server 118 further includes a call logging logic 210 in memory 206 for invoking the calendar application in which the call is logged. Once the monitoring logic 208 determines that the call is complete, the monitoring logic 208 sends a call end notification to the call logging logic 210. The call logging logic 210 also receives the call start time from the monitoring logic 208 and calculates the call duration by taking the difference between the call end time from the call start time. Thereafter, the call logging logic 210 invokes the calendar application and logs the call duration into the calendar application. One skilled in the art will understand and appreciate that the call logging logic 210 can log in other information besides the call duration into the calendar application. The information for example, could be the caller's name, remote IP address, etc. Moreover, the logging logic 210 can access information that is already stored in the calendar application and present the information to the user as needed.

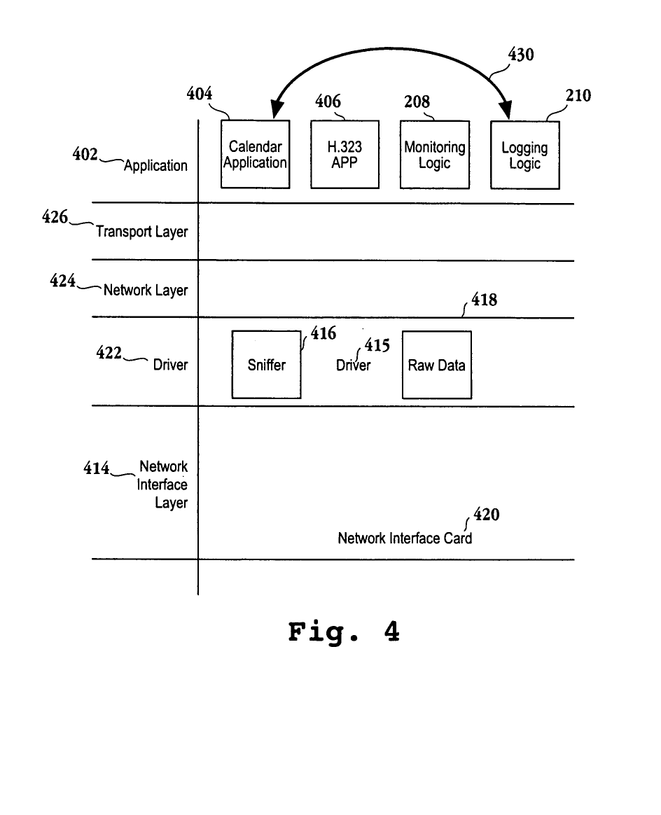

The calls that are described in the present invention take place over networks and the networks are developed with each layer responsible for a different facet of the communication. FIG. 4 illustrates the different network layers that are involved in managing and facilitating the call monitoring and logging operations in accordance with an embodiment of the present invention. The lowest layer is the network interface layer 414. The network interface layer 414 includes the network interface card 420. The network interface card 420 is used to interface with the media that is being used to facilitate communication over the network. The media may be any of the available mediums such as cable, wireless, Digital Subscriber Line (DSL) etc. The network interface layer is in communication with the driver layer 422, which is another protocol layer in the stack of network layers. The driver layer includes the device driver 415. The network interface card 420, in conjunction with the device driver 415 helps to interface with the media. The driver layer is in communication with the network layer 424. The network layer 424 is responsible for moving packets around a network. The network layer 424 may include different types of protocols such as IP, Internet Control Message Protocol (ICMP), Internet Group Management Protocol (IGMP), etc. The layer on top of the network layer 424 is the transport layer 426. The transport layer 426 provides a flow of data between the server 118 and the participants 120 or between two participants or any combination thereof. The transport layer 426 may include different types of protocols such as TCP, User Datagram Protocol (UDP), Sequence Packet Exchange (SPX), Packet Exchange Protocol (PEP), VAX OSI Transport Exchange (VOTS), Apple Talk Echo Protocol (AEP), Apple Talk Transaction Protocol (ATP), Name Building Protocol (NBP), Routing Table Maintenance Protocol (RTMP), etc. As is generally known, TCP provides more reliable transmission of data over UDP, as TCP requires a connection to be established between the two sides, before either side sends data to the other. Those skilled in the art will recognize and appreciate the details of each of the above-mentioned transport layer protocol examples. It should be understood that the principles of the present invention as described herein can be equally applied regardless of the specific transport layer protocol.

The application layer 402 lies above the transport layer 426. The application layer 426 has different protocols, which are equipped to handle the details of any application that is executed on the server 118 or participants 120. The different type of protocols at the application layer may include Telnet, File Transfer Protocol (FTP), Simple Mail Transfer Protocol, (SMTP), Simple Network Management Protocol (SNMP), File transfer, access, and management (FTAM), Remote File System (RFS), etc. Those skilled in the art will recognize and appreciate the details of each of the above-mentioned application layer protocols examples. It should be understood that the principles of the present invention as described herein can be equally applied regardless of the specific application layer protocol.

Several applications are executed at the application layer 402. FIG. 4 further illustrates some of the application programs that are executed at the application layer 402. Some of the exemplary application programs that are executed at the application layer 402 among others, are the calendar application 404, H.323 application 406, monitoring logic 208, and the logging logic 210. The monitoring logic 208 is included in sniffer 416. Sniffer 416 is configured to monitor network data. Sniffer 416 may be a self contained program or a hardware device with appropriate software or firmware programming. Sniffer 416, examines network traffic i.e. raw incoming data 418 and copies the data intercepted without redirecting or altering the intercepted data. It should be appreciated that sniffer 416 may be employed with a TCP/IP packet based network or other suitable protocols. Sniffer 416 examines the incoming packets and extracts information from the headers to determine whether an incoming packet is a TCP packet. If it is determined that the packet is a TCP packet, then the sniffer 416 proceeds to examine the packet header further to determine whether either the source port or the destination port number is equal to 1720. If the source port or the destination port number is determined to be 1720, then the sniffer 416 inspects the TCP flag field to determine whether the SYN flag bit is turned on. If the SYN flag bit is turned on, then the monitoring logic 208 monitors for the complete SYN, SYN+ACK, and ACK handshake sequence described above. Once the handshake sequence is completed, monitoring logic 208 signals the logging logic 210 to mark the start of an H.323 call. When the sniffer 416 detects a FIN flag bit, the monitoring logic 208 notifies the logging logic 210 of the end of the H.323 call. The logging logic 210 invokes the calendar application 404, via a calendar application program API, and logs the call duration into the calendar application 404.

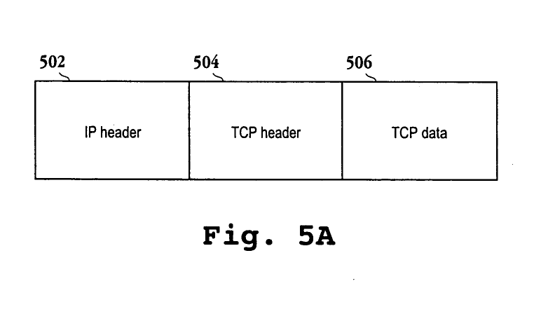

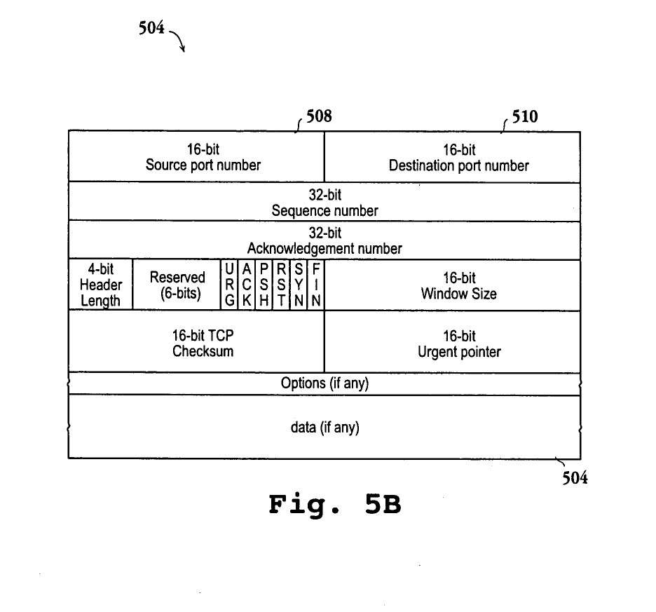

FIG. 5A shows an exemplary packet in accordance with an embodiment of the present invention. The packet as shown includes an IP header 502, a TCP header 504, and a TCP data portion 506. The TCP header 504 contains the information that is required by the sniffer 416 of FIG. 4 to make a determination as to the start and end of an H.323 call. FIG. 5B is an exemplary TCP header in accordance with an embodiment of the present invention. The TCP header 504 includes source port number 508 and the destination port number 510. As can be seen, the TCP header also contains other information, which may be extracted and logged into the existing calendar application of the user. The sniffer 416 examines an incoming packet, by inspecting the TCP header to determine whether the source or destination port number is 1720, in order to ensure that the incoming call is an H.323 call.

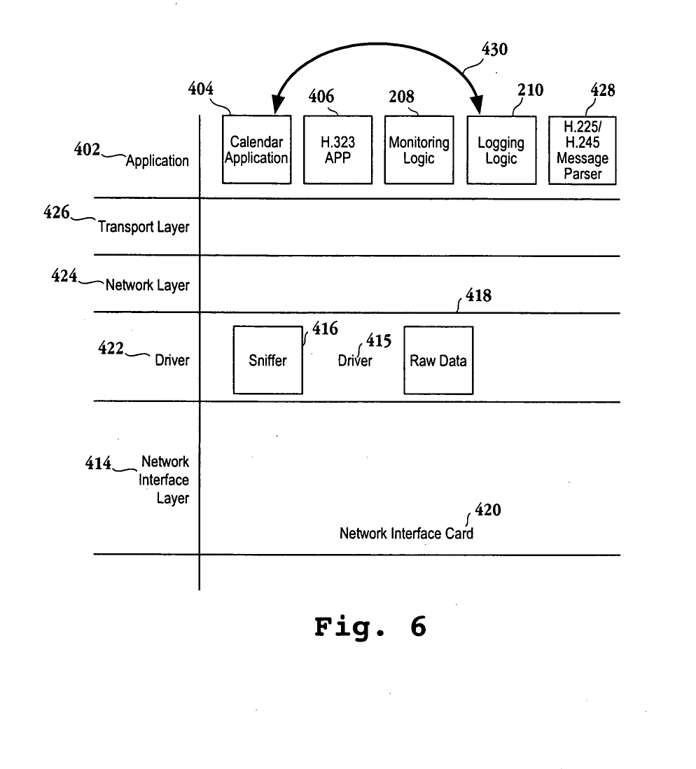

FIG. 6 illustrates the different network layers that are involved in managing and facilitating the call monitoring and logging operations in accordance with an embodiment of the present invention. FIG. 6 is similar to FIG. 4 except that the application layer 402 further includes message parsing logic 428. FIG. 6 also shows the network interface layer 414, and network layer 424, transport layer 426, and the application layer 402. The functions of these layers are described in detail with respect to FIG. 4. The message parser logic 428 helps to extract additional caller information about the incoming call. The parser logic 428 is configured to parse through the message to get information such as the calling party's name, among other information from the TCP 1720 connection. In one embodiment, message parser logic 428 is an H.225/H.245 parser. The H.225/H.245 parser extracts call information from the H.323 call during the call setup phase. The call information may include caller's name, the caller's IP address, call identifier, such as the 128-bit globally unique identification number for the call, among others. In another embodiment, the message parser logic 428 is integrated with the monitoring logic.

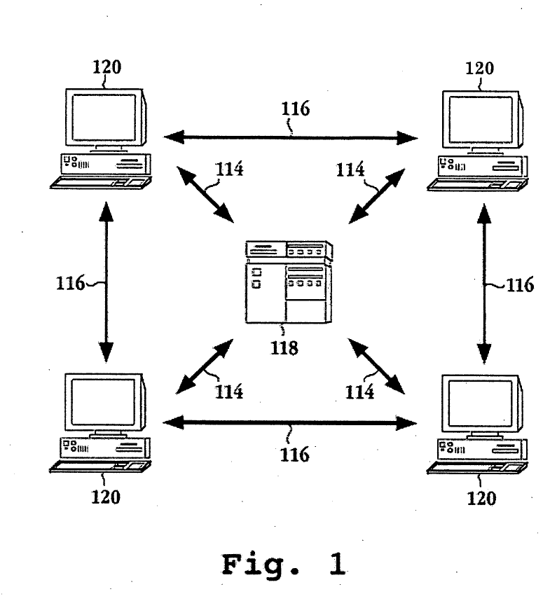

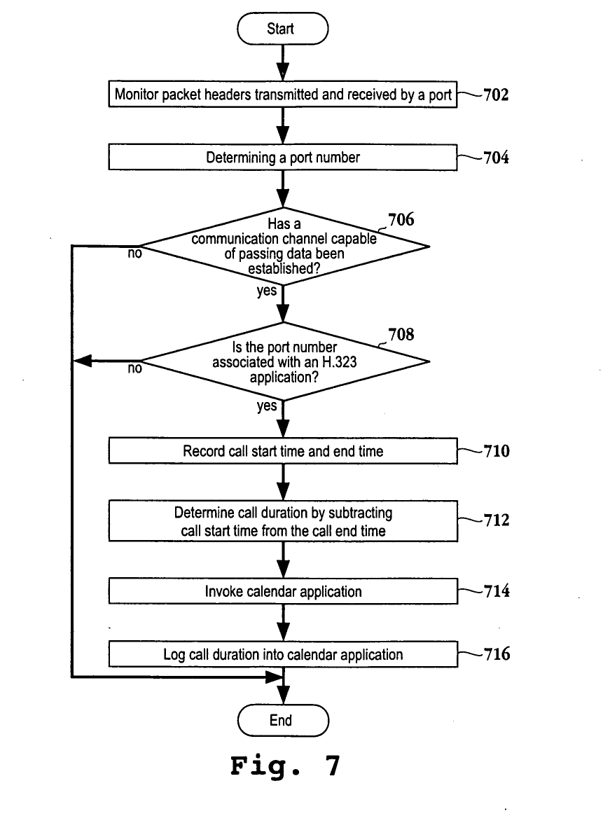

FIG. 7 is a flowchart providing an overview of the different operations involved in automatic call-logging of H.323 calls, in accordance with an embodiment of the present invention. The operation begins at operation 702 where a monitoring logic, present in the memory of a server, of the type described with respect to FIG. 1, monitors packet headers transmitted and received by a port. As described above, certain port numbers are synonymous with certain type of data messages. For example, port number 1720 is the default port for H.323 data messages. Therefore, when the monitoring logic inspects packet headers the monitoring logic first determines whether the packet is a TCP packet. If the packet is determined to be a TCP packet, then the monitoring logic inspects the TCP header, for the port number as shown in operation 704. In operation 706, the monitoring logic makes a determination as to whether a communication channel capable of passing data has been established. In one embodiment, the communication channel is said to be established, when the connection to the port as well as the H.323 handshake, is complete. If a communication channel capable of passing data has been established, then in operation 708 a determination is made whether the port number is associated with an H.323 application. In one embodiment, the port number associated with the H.323 application is port 1720, therefore, a determination of whether the port number is 1720 is made in operation 708.

Once the port number is determined to be one that is associated with an H.323 application, then in operation 710 the monitoring logic alerts the logging logic to record call start time. When the monitoring logic senses a port 1720 connection termination, the monitoring logic alerts the logging logic to record the call end time as shown in operation 710. Once the call is ended, then in operation 712, the logging logic determines the call duration by subtracting the call start time from the call end time. Thereafter in operation 714, the logging logic invokes a calendar application via the calendar application API. The method then advances to operation 716, where the duration of the call is logged into the calendar application. It should be appreciated that the calendar application may be any commercially available calendar applications, which include calendar application associated with commonly used email applications. As mentioned above, additional information may be recorded as provided through parser logic.

As described above, the advantages of the present invention are numerous. Firstly, the call-logging feature function is independent of a particular application. As a result, the present invention can function with any of the existing calendar application of the user. Therefore, the user only needs to learn to use his/her calendar application. In addition, regardless of the number of different H.323 applications a user likes to run, the invention is adaptable to the many different H.323 applications. The present invention virtually eliminates the need for custom user interface, in order to access a call log.

With the above embodiments in mind, it should be understood that the invention may be practiced with other computer system configurations including hand-held devices, microprocessor systems, microprocessor-based or programmable consumer electronics, minicomputers, mainframe computers and the like. Furthermore, the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which thereafter can be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for recording call-logging information, comprising:
monitoring packet headers transmitted from and received by a port associated with a computer device;
determining a port number for the port associated with the computer device;
identifying if a communication channel capable of passing data has been established;
if the port number is associated with an H.323 application and the communication channel has been established, then the method includes,
recording a call duration for the port number associated with the H.323 application;
invoking a calendar application; and
logging the call duration into the calendar application.

2. A method for recording call-logging information as recited in claim 1, wherein the method of monitoring packet headers includes,
monitoring the packet headers for TCP packets.

3. A method for recording call-logging information as recited in claim 1, further comprising:
determining if port number 1720 connection has been established.

4. A method for recording call-logging information as recited in claim 1, further comprising:
determining if a H.323 handshake has been completed.

5. A method for recording call-logging information as recited in claim 1, wherein the method of recording a call duration for the port number associated with the H.323 application includes,
recording a call start time;
recording a call end time upon communication channel termination; and
determining the call duration by subtracting the call start time from the call end time.

6. A method for recording call-logging information as recited in claim 5, wherein the method of recording call end time includes,
recording the call end time when a connection to port 1720 is terminated.

7. A method for call-logging as recited in claim 1, wherein the method of invoking a calendar application includes, invoking the calendar application via a calendar application API.

8. A method for call-logging as recited in claim 1, wherein the method of monitoring packet headers includes,
determining whether a SYN flag bit in a TCP packet header is turned on, and
a handshake sequence is completed.

9. A method for call-logging as recited in claim 8 wherein the handshake sequence includes, exchanging packets with SYN, SYN+ACK, and ACK TCP between a client and a server.

10. A method for call-logging as recited in claim 5, wherein the method operation of recording a call end time includes,
determining whether a FIN flag bit in a TCP header is turned on.

11. A system for call-logging comprising:
a central processing unit (CPU);
a memory unit in communication with the CPU, wherein the memory unit includes,
monitoring logic, the monitoring logic configured to monitor network traffic data being received by the system; and
logging logic configured to invoke a calendar application in response to being notified by the monitoring logic that an H.323 call has ended.

12. A system for call-logging as recited in claim 11, wherein the monitoring logic is configured to monitor packet headers of the network traffic data being received by the system.

13. A system for call-logging as recited in claim 12, wherein the monitoring logic is configured to extract information from packet headers and, based on the information, a determination is made as to whether the packet is a TCP packet to or from port 1720 of the system.

14. A system for call-logging as recited in claim 11, wherein the monitoring logic is configured to notify the logging logic of an H.323 call start based on information extracted from packet headers from the network traffic data.

15. A system for call-logging as recited in claim 12, wherein the monitoring logic is configured to determine if a SYN flag bit in packet headers, is associated with an ON state, and completion of a handshake sequence, both of which are indicative of an H.323 call start.

16. A system for call-logging as recited in claim 15, wherein the handshake sequence includes, exchanging TCP packets with SYN, SYN+ACK, and ACK between a client and a server.

17. A system for call-logging as recited in claim 12, wherein the monitoring logic is configured to determine if a FIN flag bit in packet headers, is associated with an ON state indicative of an end of an H.323 call.

18. A system for call-logging as recited in claim 1, wherein the calendar application is incorporated into an email application.

19. A system for call-logging as recited in claim 11, wherein the logging logic is configured to log a call duration into the calendar application.

20. A system for call-logging comprising:
a central processing unit (CPU);
a memory unit in communication with the CPU, wherein the memory unit includes,
a sniffer configured to monitor network traffic data being received by the system;
logging logic configured to log a call duration into a calendar application by invoking the calendar application in response to being notified by the monitoring logic that a call has ended; and
parser logic for parsing the network traffic data to extract network data content information.

21. A system for call-logging as recited in claim 20, wherein the parser logic includes an H.225/H.245 network traffic data parser.

22. A system for call-logging as recited in claim 20, wherein the logging logic is configured to log the content information derived by the parser logic along with the call duration.

23. A system for call-logging as recited in claim 20, wherein the network data content information includes a calling party's name and other information related to the call.
